(19) United States
(12) Patent Application Publication
(10) Pub. No.: US 2023/0361312 A1
(43) Pub. Date: Nov. 9, 2023

(54) Bipolar Storage Battery

(71) Applicants: The Furukawa Battery Co., Ltd., Yokohama (JP); Furukawa Electric Co., Ltd., Tokyo (JP)

(72) Inventors: Kenji Hirota, Iwaki (JP); Yoshinobu Taira, Iwaki (JP); Hideo Nishikubo, Iwaki (JP); Kenichi Suyama, Tokyo (JP); Hiroki Tanaka, Tokyo (JP); Yasuo Nakajima, Tokyo (JP); Akira Tanaka, Tokyo (JP)

(21) Appl. No.: 18/356,578

(22) Filed: Jul. 21, 2023

Related U.S. Application Data
(63) Continuation of application No. PCT/JP2021/041932, filed on Nov. 15, 2021.

(30) Foreign Application Priority Data
Jan. 22, 2021 (JP) 2021-008959

(51) Int. Cl. H01M 4/68; H01M 10/18

(52) U.S. Cl. CPC H01M 4/685; H01M 10/18

(57) ABSTRACT

Provided is a bipolar storage battery in which an electrolytic solution is less likely to enter the interface between a positive electrode and an adhesive layer. Thus, battery performance is less likely to be reduced even if growth occurs in the positive electrode due to corrosion by sulfuric acid contained in the electrolytic solution. The bipolar storage battery includes a bipolar plate including a support column configured to support adjacent plates to each other when stacked, a positive current collector bonded to one surface of the bipolar plate by an adhesive, a positive active material layer placed on the positive current collector, a negative current collector bonded to another surface of the bipolar plate by an adhesive, a negative active material layer placed on the negative current collector, and a cover plate covering a peripheral edge portion of the positive current collector.

### CROSS-REFERENCE TO RELATED APPLICATION(S)

This application is a continuation of PCT Application No. PCT/JP2021/041932, filed Nov. 15, 2021, the disclosure of which is incorporated herein in its entirety by reference.

### TECHNICAL FIELD

Embodiments of the present invention relate to a bipolar storage battery.

### BACKGROUND

A bipolar lead-acid storage battery includes a bipolar electrode including a positive electrode, a negative electrode, and a substrate (bipolar plate). The positive electrode is provided on one surface of the substrate and the negative electrode is provided on the other surface of the substrate. As illustrated in FIG. 6A, a positive electrode of a conventional bipolar electrode is configured such that a positive lead layer 220 is provided on one surface of a substrate 210 made of resin via an adhesive layer 240, and a positive active material layer (not illustrated) is provided on the positive lead layer 220.

### SUMMARY

In a bipolar lead-acid storage battery like that described above, the positive lead layer 220 can be corroded by sulfuric acid contained in the electrolytic solution, and a corrosion product (lead oxide) coating 260 can be generated on a surface of the positive lead layer 220 (see FIG. 6B). Then, there is a concern that elongation (growth) occurs in the positive lead layer 220 due to the growth of the corrosion product coating 260.

Further, there is a concern that, if the positive lead layer 220 and the adhesive layer 240 are separated and the positive lead layer 220 is turned up due to the growth, the electrolytic solution enters the interface between the positive lead layer 220 and the adhesive layer 240. The corrosion of the positive lead layer 220 due to sulfuric acid further progresses (see FIG. 6C). As a result, there is a case where, for example, if the electrolytic solution goes along the back surface (the surface facing the substrate 210) of the positive lead layer 220 and reaches negative lead foil (not illustrated), a short circuit (liquid junction) or the like occurs, and the performance of the battery is reduced.

A surface of the positive lead layer 220 (the positive electrode) on which corrosion due to sulfuric acid has progressed because of the entry of the electrolytic solution into the interface between the positive lead layer 220 (the positive electrode) and the adhesive layer 240 caused by growth is hereinafter referred to as a “creeping surface,” as appropriate. Further, the distance at which corrosion has progressed is referred to as a “creeping distance,” as appropriate.

An object of the present invention is to provide a bipolar storage battery in which an electrolytic solution is less likely to enter the interface between a positive electrode and an adhesive layer and battery performance is less likely to be reduced even if growth occurs in the positive electrode due to corrosion by sulfuric acid contained in the electrolytic solution.

A bipolar storage battery according to an embodiment of the present invention includes a bipolar plate including a support column configured to support adjacent plates to each other when stacked, a positive current collector bonded to one surface of the bipolar plate by an adhesive, a positive active material layer placed on the positive current collector, a negative current collector bonded to another surface of the bipolar plate by an adhesive, a negative active material layer placed on the negative current collector, and a cover plate covering a peripheral edge portion of the positive current collector.

By employing such a configuration, even if growth occurs in the positive electrode due to corrosion by sulfuric acid contained in the electrolytic solution, the entry of the electrolytic solution into a peripheral edge portion of the positive current collector can be prevented as much as possible by the presence of the cover plate. Therefore, the electrolytic solution is less likely to enter the interface between the positive electrode and the adhesive layer, and the reaching of the electrolytic solution to the negative electrode can be delayed. Thus, battery performance is less likely to be reduced.

### BRIEF DESCRIPTION OF THE DRAWINGS

FIG. 1 is a cross-sectional view partially illustrating a structure of a bipolar lead-acid storage battery according to an embodiment of the present invention.

FIG. 2 is an enlarged cross-sectional view of a bipolar electrode illustrating a structure of a peripheral edge portion of positive lead foil, the peripheral edge portion being a main portion of the bipolar lead-acid storage battery according to the embodiment.

FIG. 3 is an enlarged cross-sectional view of the bipolar electrode illustrating a structure of a peripheral edge portion of a support column, the peripheral edge portion being a main portion of the bipolar lead-acid storage battery according to the embodiment.

FIG. 4 is a plan view of the bipolar electrode illustrating a structure of a main portion of the bipolar lead-acid storage battery according to the embodiment.

FIG. 5 is an enlarged cross-sectional view of the bipolar electrode illustrating effects in the bipolar lead-acid storage battery according to the embodiment.

FIG. 6A, FIG. 6B, and FIG. 6C are diagrams illustrating a situation where, in a conventional bipolar lead-acid storage battery, an electrolytic solution enters the interface between a positive lead layer and an adhesive layer as a result of growth occurring in the positive lead layer due to corrosion by sulfuric acid contained in the electrolytic solution.

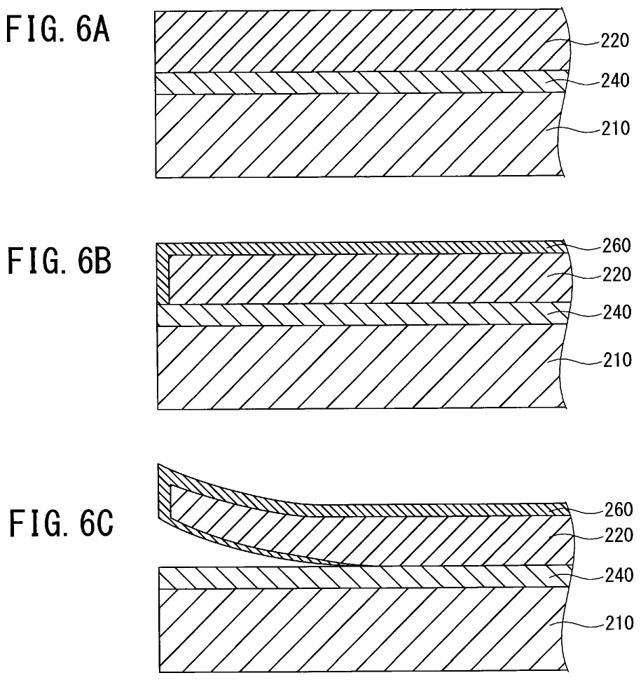

### DETAILED DESCRIPTION

Hereinafter, an embodiment of the present invention will be described in detail with reference to the drawings. Note that the embodiment described below illustrates an example of the present invention. Various changes or improvements can be added to the present embodiment, and a mode to which such changes or improvements are added can also be included in the present invention. This embodiment and modifications thereof are included in the scope and gist of the invention and are included in the scope of the invention described in the claims and its equivalents. Note that, hereinafter, a lead-acid storage battery will be described as an example from among various storage batteries.

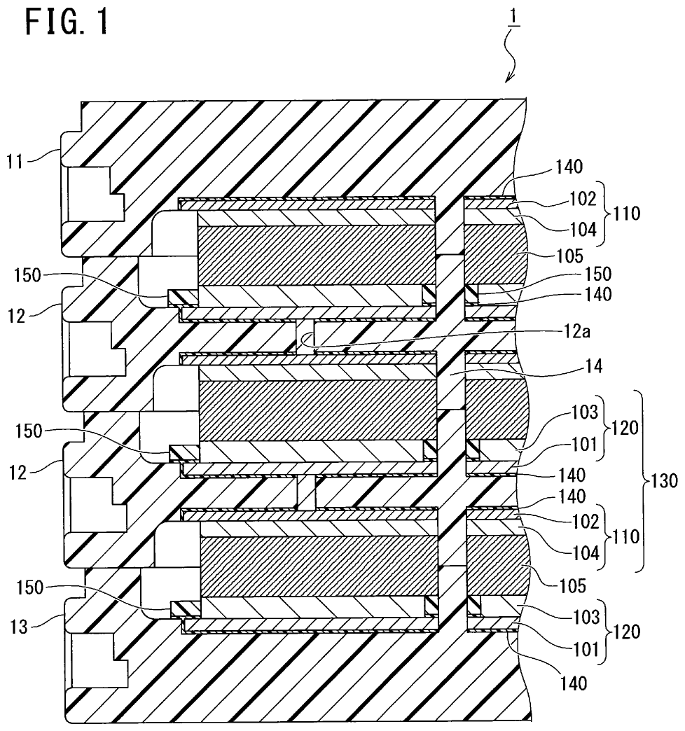

A structure of a bipolar lead-acid storage battery 1 according to the embodiment of the present invention will be described with reference to FIG. 1. FIG. 1 is a cross-sectional view partially illustrating a structure of the bipolar lead-acid storage battery 1 according to an embodiment of the present invention.

The bipolar lead-acid storage battery 1 illustrated in FIG. 1 includes a first end plate 11, bipolar plates 12, and a second end plate 13. The first end plate 11 is formed in a recessed shape, and a negative electrode 110 is fixed to the recess via an adhesive 140. The bipolar plate 12 is formed in an H shape and includes a bipolar electrode 130. A positive electrode 120 is provided on one surface of the bipolar electrode 130, the one surface being configured to be parallel to the recess of the first end plate 11, and a negative electrode 110 is provided on another surface of the bipolar electrode 130. The second end plate 13 is formed in a recessed shape, and a positive electrode 120 is fixed to the recess via an adhesive 140.

An electrolytic layer 105 (also called a separator) is provided between a positive active material layer 103 and a negative active material layer 104. The electrolytic layer 105 is in contact with both the positive active material layer 103 and the negative active material layer 104. The electrolytic layer 105 is formed of, for example, a glass fiber mat impregnated with an electrolytic solution containing sulfuric acid.

Bipolar plates 12 are stacked between the first end plate 11 and the second end plate 13 to form, for example, a bipolar lead-acid storage battery 1 having a substantially rectangular parallelepiped shape. Although FIG. 1 illustrates a bipolar lead-acid storage battery 1 in which two bipolar plates 12 are stacked, the number of stacked bipolar plates 12 is set such that the storage capacity of the bipolar lead-acid storage battery 1 is a desired numerical value.

A negative electrode terminal (not illustrated) is fixed to the first end plate 11, and the negative electrode terminal is electrically connected to the negative electrode 110 fixed to the first end plate 11. A positive electrode terminal (not illustrated) is fixed to the second end plate 13, and the positive electrode terminal is electrically connected to the positive electrode 120 fixed to the second end plate 13.

The first end plate 11 and the second end plate 13 are each formed of, for example, a known molding resin. The first end plate 11, the bipolar plate 12, and the second end plate 13 are fixed to each other by an appropriate method such that the interior is sealed so that the electrolytic solution does not flow out.

In a substantially central portion of the first end plate 11, the bipolar plate 12, and the second end plate 13, there is provided a support column 14 configured to support adjacent plates to each other when these plates are stacked.

Although the embodiment of the present invention assumes that the support column 14 is provided only in a substantially central portion, the support column 14 may be provided not only in one place but also in a plurality of places.

The bipolar plate 12 is formed of, for example, a thermoplastic resin. Examples of the thermoplastic resin to form the bipolar plate 12 include an acrylonitrile-butadiene-styrene copolymer (ABS) resin or polypropylene. These thermoplastic resins are excellent in moldability and in sulfuric acid resistance. Hence, even if the electrolytic solution contacts the bipolar plate 12, the bipolar plate 12 is less likely to experience decomposition, deterioration, corrosion, etc.

The bipolar plate 12 is provided with a conduction hole 12a configured to allow one surface and the other surface to communicate with each other. Then, positive lead foil 101 and negative lead foil 102 are joined via the conduction hole 12a to electrically connect both pieces of foil, and a conduction portion between the positive electrode 120 and the negative electrode 110 is formed.

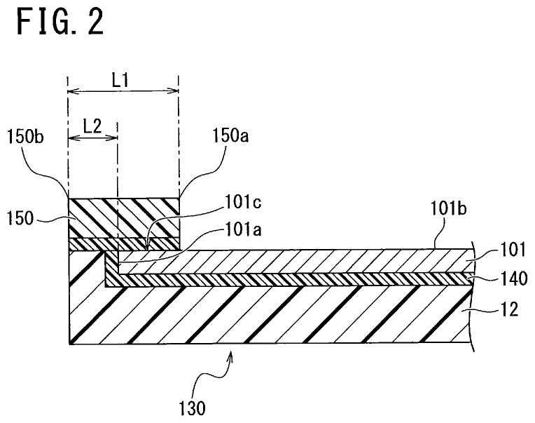

The positive electrode 120 includes positive lead foil 101 placed on one surface of the bipolar plate 12, the positive lead foil 101 being a positive current collector made of lead or a lead alloy, and a positive active material layer 103 placed on the positive lead foil 101. The positive lead foil 101 is bonded to one surface of the bipolar plate 12 by an adhesive 140 provided between the one surface of the bipolar plate 12 and the positive lead foil 101. Therefore, the adhesive 140, the positive lead foil 101, and the positive active material layer 103 are stacked in this order on one surface of the bipolar plate 12 (in drawings such as FIG. 2 described later, the surface facing upward on the drawing sheet).

The negative electrode 110 includes negative lead foil 102 placed on the other surface of the bipolar plate 12, the negative lead foil 102 being a negative current collector made of lead or a lead alloy, and a negative active material layer 104 placed on the negative lead foil 102. The negative lead foil 102 is bonded to the other face of the bipolar plate 12 by an adhesive 140 provided between the other face of the bipolar plate 12 and the negative lead foil 102. The positive electrode 120 and negative electrode 110 are electrically connected through the conduction hole 12a described above.

In the following cross-sectional views of the bipolar electrode 130 including FIG. 2, illustration of the positive active material layer 103 and the electrolytic layer 105 is omitted. Similarly, illustration of the negative electrode 110 formed on the other surface of the bipolar plate 12 is omitted.

In the bipolar lead-acid storage battery 1 according to the embodiment of the present invention, as described above, the bipolar plate 12, the positive lead foil 101, the positive active material layer 103, the negative lead foil 102, and the negative active material layer 104 constitute the bipolar electrode 130. The bipolar electrode 130 refers to an electrode having functions of both a positive electrode and a negative electrode in one electrode. The bipolar lead-acid storage battery 1 of the embodiment of the present invention has a battery configuration in which a plurality of cell members, each formed by interposing the electrolytic layer 105 between the positive electrode 120 and the negative electrode 110, are alternately stacked and assembled to connect the cell members in series.

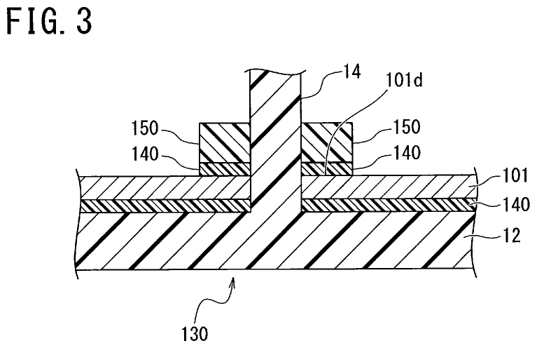

Next, a structure of an end portion of the positive lead foil 101 in the bipolar electrode 130 according to an embodiment of the present invention is described below using FIGS. 1, 2, and 3. FIG. 2 is an enlarged cross-sectional view of the bipolar electrode 130 illustrating a peripheral edge portion 101c of the positive lead foil 101. The peripheral edge portion 101c is a structure of a main portion of the bipolar lead-acid storage battery 1 according to the embodiment of the present invention. FIG. 3 is an enlarged cross-sectional view of the bipolar electrode 130 illustrating a structure of a peripheral edge portion 101d of the support column 14. The peripheral edge portion 101d is a main portion of the bipolar lead-acid storage battery 1 according to an embodiment of the present invention.

In the bipolar electrode 130 in FIGS. 2 and 3, the illustration of components other than the bipolar plate 12, the adhesive 140, or the positive lead foil 101 is omitted. That is, the illustration of the positive active material layer 103, the negative electrode 110, and the adhesive 140 on the negative electrode side bonding the negative lead foil 102 to the bipolar plate 12 is omitted.

As illustrated in FIG. 2, the bipolar plate 12 includes, for example, a portion extending in the horizontal direction on the drawing sheet. For the portion extending in the horizontal direction, the illustration of a right portion is omitted in FIG. 2, and the illustration of both end portions is omitted in FIG. 3.

In the bipolar electrode 130 illustrated in FIG. 2, the positive lead foil 101 is bonded onto a portion extending in the horizontal direction, the portion forming one surface of the bipolar plate 12, via the adhesive 140. The adhesive 140 is provided not only between the one surface of the bipolar plate 12 and a surface of the positive lead foil 101 facing the one surface, but also on a surface (hereinafter, this surface is referred to as a facing surface 101b, as appropriate) including an end portion 101a of the positive lead foil 101 and facing a surface of the positive lead foil 101 on which the positive lead foil 101 is bonded to the one surface of the bipolar plate 12.

The adhesive 140 is provided in a flange shape on a portion extending in the horizontal direction, the portion forming the one surface of the bipolar plate 12, to connect an area between the one surface of the bipolar plate 12 and a surface of the positive lead foil 101 facing the one surface, and the facing surface 101b.

In the bipolar electrode 130 in the embodiment of the present invention, a cover plate 150 is further bonded onto the adhesive 140 provided on the facing surface 101b.

Here, examples of the cover plate 150 include an acrylonitrile-butadiene-styrene copolymer (ABS) resin or polypropylene. These thermoplastic resins are excellent in moldability and in sulfuric acid resistance. Hence, even if the electrolytic solution contacts the cover plate 150, the cover plate 150 is less likely to experience decomposition, deterioration, corrosion, etc.

The cover plate 150 illustrated in FIG. 2 is mounted on the adhesive 140 provided on the facing surface 101b to cover the end portion 101a of the positive lead foil 101. Therefore, the cover plate 150 is fixed to the bipolar plate 12 and the positive lead foil 101 via the adhesive 140. At this time, the cover plate 150 is more preferably provided to press the positive lead foil 101.

The cover plate 150 is placed such that one end 150a of the cover plate 150 includes a position where the adhesive 140 is provided on the facing surface 101b, and an end surface of the adhesive 140 does not get over (i.e., does not protrude from) the one end 150a in terms of the distance from the end portion 101a of the positive lead foil 101.

On the other hand, the other end 150b of the cover plate 150 is mounted on the adhesive 140 provided in a flange shape on a portion extending in the horizontal direction, the portion forming the one surface of the bipolar plate 12.

Therefore, the cover plate 150 covers the adhesive 140 provided on a peripheral edge portion 101c of the positive lead foil 101 including the end portion 101a of the positive lead foil 101, and the entire surface of the cover plate 150 is in contact with the adhesive 140. That is, by the cover plate 150 being provided in such a position, the peripheral edge portion 101c of the positive lead foil 101 is covered by the cover plate 150.

When mounting the cover plate 150 on the adhesive 140, such as illustrated in FIG. 2, the cover plate 150 is preferably placed such that the ratio between distance L1 and distance L2 is 9:4, where L1 is the distance from one end 150a to the other end 150b of the cover plate 150, and L2 is the distance from the end portion 101a of the positive lead foil 101 to the other end 150b of the cover plate 150.

Thus, the bipolar electrode 130 includes a cover plate 150 covering a peripheral edge portion 101c including four corners of the positive lead foil 101. In an embodiment of the present invention, the cover plate 150 covers part of the positive lead foil 101 via the adhesive 140. As described above, the region of the positive lead foil 101 covered by the cover plate 150 is a region including the end portion 101a and having a predetermined ratio indicated by the width of the cover plate 150 (the length between one end 150a and the other end 150b), the width being indicated by reference sign L1, and the end portion 101a.

The peripheral edge portion of the positive lead foil 101 includes not only the peripheral edge portion 101c including four corners of the positive lead foil 101 described above but also the surroundings of the support column 14. That is, in an embodiment of the present invention, as illustrated in FIGS. 1 and 3, the cover plate 150 is provided also on a peripheral edge portion 101d of the support column 14, on the adhesive 140 provided on the facing surface 101b of the positive lead foil 101.

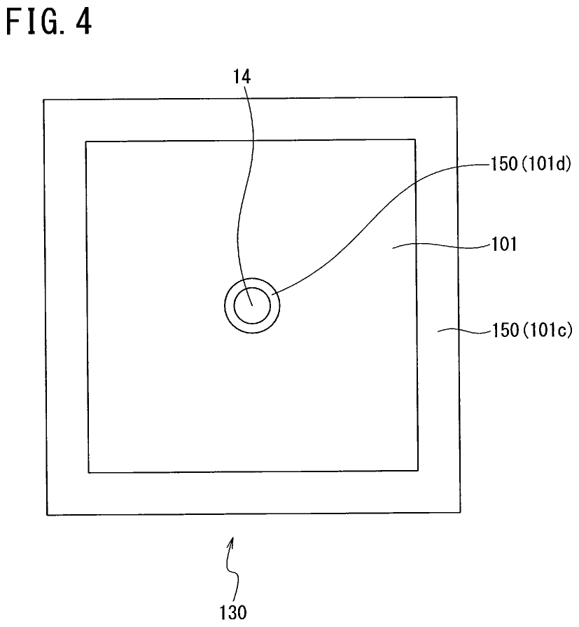

That is, as illustrated in the plan view of FIG. 4 of the bipolar electrode 130, which illustrates a structure of a main portion of the bipolar lead-acid storage battery 1 according to an embodiment of the present invention, the peripheral edge portion 101c of the positive lead foil 101 is covered with the cover plate 150 in a frame shape. Further, the cover plate 150 is provided also on the peripheral edge portion 101d of the support column 14 to be in contact with the periphery of the support column 14 and surround the peripheral edge portion 101d. For the width relationship, it is preferable that the width of the cover plate 150 in a frame shape provided on the peripheral edge portion 101c of the positive lead foil 101 be larger than the width of the cover plate 150 provided to surround the peripheral edge portion 101d of the support column 14. This is because, when the cover plate 150 provided in a frame shape is larger than the cover plate 150 provided in a surrounding manner, the electrolytic solution entering the interface between the positive lead foil 101 and the adhesive 140 when growth occurs and both components are separated can be better prevented. The width of the cover plate 150 provided in a frame shape is preferably three to four times the width of the cover plate 150 provided in a surrounding manner.

In an embodiment of the present invention, only one support column 14 is provided as described above. When the bipolar plate 12 is provided with a plurality of support columns 14, the cover plate 150 is provided on the peripheral edge portions 101d of all the support columns 14.

Although examples of the material of the cover plate 150 are given above, the material may not be limited to such materials. That is, materials having sulfuric acid resistance (i.e., that are less likely to be corroded by sulfuric acid) may be used as the cover plate 150, such as metals having sulfuric acid resistance (for example, stainless steel) or ceramics.

By thus providing the cover plate 150 on a region including the end portion 101a of the positive lead foil 101 (the peripheral edge portion 101c) and the peripheral edge portion 101d of the support column 14, the entry of the electrolytic solution can be prevented as much as possible in a portion of the positive lead foil 101 where the electrolytic solution is likely to enter. Therefore, even if growth occurs, an event where the electrolytic solution enters the interface between the positive lead foil 101 and the adhesive 140 when both components are separated can be prevented.

As illustrated in FIG. 2, herein it is assumed that the adhesive 140 for bonding the cover plate 150 covers the end portion 101a of the positive lead foil 101 and is integrated with the adhesive 140 provided between one surface of the bipolar plate 12 and the positive lead foil 101. This integrated state is created by, for example, when mounting the cover plate 150 to cover the end portion 101a of the positive lead foil 101, using a surplus adhesive 140 when bonding the positive lead foil 101 to one surface of the bipolar plate 12.

In addition to this, when mounting the cover plate 150, the adhesive 140 may be provided on a position of the peripheral edge portion 101c on the facing surface 101b where the cover plate 150 is to be mounted, as a step different from the adhesive 140 used when bonding the positive lead foil 101 to one surface of the bipolar plate 12.

Examples of the adhesive 140 used in the bipolar lead-acid storage battery 1 of an embodiment of the present invention include a cured product of a reaction-curable adhesive in which a main agent containing an epoxy resin and a curing agent containing an amine compound react with each other and cure.

That is, this cured product has a property of being less likely to be attacked by sulfuric acid, whereby sulfuric acid is less likely to enter the interface between the positive lead foil 101 and the adhesive 140. Further, the cured product is less likely to experience decomposition, deterioration, corrosion, etc., even on contact with the electrolytic solution. Thus, the positive lead foil 101 and the adhesive 140 are firmly bonded to each other. Therefore, even if growth occurs in the positive lead foil 101 due to corrosion by sulfuric acid contained in the electrolytic solution, the entry of the electrolytic solution into the interface between the positive lead foil 101 and the adhesive 140 is suppressed. Furthermore, a problem that corrosion by sulfuric acid reaches a surface facing the bipolar plate 12 of the positive electrode 120 and a short circuit or the like occurs such that the performance of the battery is reduced is less likely to occur.

Examples of the epoxy resin contained in the main agent include at least one of a bisphenol A type epoxy resin and a bisphenol F type epoxy resin. For the epoxy resin, one kind may be used alone, or two or more kinds may be used in combination.

Examples of the amine compound contained in the curing agent include an aliphatic polyamine compound, an alicyclic polyamine compound, and an aromatic polyamine compound. For these amine compounds, one kind may be used alone, or two or more kinds may be used in combination.

Specific examples of the aliphatic polyamine compound include aliphatic primary amines such as triethylenetetramine (C₆H₁₈N₄) and aliphatic secondary amines such as triethylenetetramine. Specific examples of the alicyclic polyamine compound include alicyclic primary amines such as isophoronediamine (C₁₀H₂₂N₂). Specific examples of the aromatic polyamine compound include aromatic primary amines such as diaminodiphenylmethane (C₁₃H₁₄N₂).

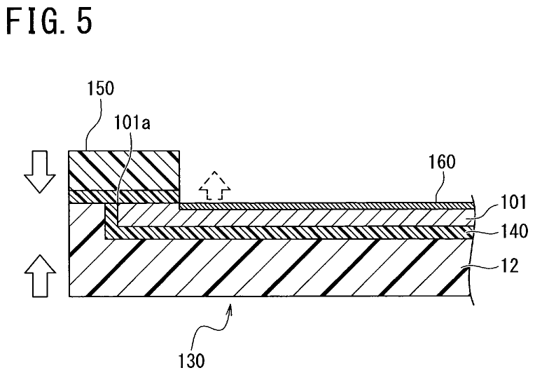

FIG. 5 is an enlarged cross-sectional view of the bipolar electrode 130 illustrating effects in the bipolar lead-acid storage battery 1 according to an embodiment of the present invention. In FIG. 5, illustration of the support column 14 is omitted.

In the bipolar electrode 130 illustrated in FIG. 5, a state is illustrated in which the positive lead foil 101 is corroded by sulfuric acid contained in the electrolytic solution and a corrosion product (lead oxide) coating 160 is generated on a surface of the positive lead foil 101.

That is, a surface of the positive lead foil 101 on which the coating 160 is generated is a creeping surface, and the creeping distance is extended by the growth of the coating 160. If growth occurs in the positive lead foil 101 due to the growth of the coating 160, the force of the growth is applied to the upper side (the side of the positive active material layer 103, the illustration of which is omitted in FIG. 5) as indicated by the direction of the arrow drawn by a broken line in FIG. 5.

However, as described above, in the bipolar lead-acid storage battery 1 in an embodiment of the present invention, the cover plate 150 is provided to cover the peripheral edge portion 101c including the end portion 101a of the positive lead foil 101. By employing such a configuration, for example, even if growth occurs, an event where sulfuric acid enters a portion between the positive lead foil 101 and the adhesive 140 and a coating 160 is generated can be made less likely to occur by the force in the up-down direction (the direction of the arrow drawn by a solid line in FIG. 5) by the bipolar plate 12 and the cover plate 150.

Further, the entire surface from one end 150a to the other end 150b of the cover plate 150 is bonded to the adhesive 140. Thus, as illustrated in FIG. 5, not only the entry of the electrolytic solution from the side of the positive lead foil 101 and the positive active material layer 103 can be made less likely to occur. That is, the entry of the electrolytic solution from the one end 150a side of the cover plate 150 but also the entry of the electrolytic solution from the other end 150b side can be made less likely to occur.

These effects lead to a delay in advancement of growth and an increase in creeping distance, and if the advancement of growth can be delayed, an event where the electrolytic solution enters the interface between the positive lead foil 101 and the adhesive 140 when both components are separated and turned up can be suppressed more. As a result, the electrolytic solution reaching the negative electrode can be delayed, and battery performance is less likely to be reduced.

The action and effect described above with regard to the peripheral edge portion 101c of the positive lead foil 101 are similarly exhibited in the cover plate 150 provided on the peripheral edge portion 101d of the support column 14.

As described above, embodiments of the present invention are described using a positive electrode as an example. Although it is sufficient that the cover plate be thus provided at least on the positive electrode, the described structure can be employed also on the negative electrode.

As described above, embodiments of the present invention are described using a bipolar lead-acid storage battery as an example. However, when the above description applies to other storage batteries in which other metals are used instead of lead for current collectors, the application of the above description is not excluded.

It should be noted that the following configuration can also be adopted for the technology described in the embodiments of the present invention.
(1) A bipolar storage battery comprising: a bipolar plate including a support column configured to support adjacent plates to each other when stacked;
   a positive current collector bonded to one surface of the bipolar plate by an adhesive;
   a positive active material layer placed on the positive current collector;
   a negative current collector bonded to another surface of the bipolar plate by an adhesive;
   a negative active material layer placed on the negative current collector; and
   a cover plate covering a peripheral edge portion of the positive current collector.
(2) The bipolar storage battery according to (1), wherein the peripheral edge portion includes a peripheral edge portion of the support column, and the cover plate covers the peripheral edge portion of the support column.
(3) The bipolar storage battery according to (1) or (2), wherein the cover plate is made of an acrylonitrile-butadiene-styrene copolymer or polypropylene.
(4) The bipolar storage battery according to any one of (1) to (3), wherein the cover plate is placed at least on an adhesive provided on the positive electrode, and one end of the cover plate is placed to cover a region on which the adhesive is provided.
(5) The bipolar storage battery according to any one of (1), (3), or (4), wherein the cover plate covers an end portion of the positive electrode and has a frame shape.
(6) The bipolar storage battery according to any one of (1) to (5), wherein the positive current collector and the negative current collector are made of lead or a lead alloy.

The following is a list of reference signs used in this specification and in the drawings.
1 bipolar lead-acid storage battery
11 first end plate
12 bipolar plate
12a conduction hole
13 second end plate
14 support column
101 positive lead foil
101a end portion
101b facing surface
101c peripheral edge portion
101d peripheral edge portion
102 negative lead foil
103 positive active material layer
104 negative active material layer
105 electrolytic layer
110 negative electrode
120 positive electrode
130 bipolar electrode
140 adhesive
150 cover plate
150a one end
150b other end
160 coating
210 substrate
220 positive lead layer
240 adhesive layer
260 corrosion product coating

1 A bipolar storage battery, comprising:
a bipolar plate including a support column configured to support adjacent plates to each other when stacked;
a positive current collector bonded to one surface of the bipolar plate by an adhesive;
a positive active material layer placed on the positive current collector;
a negative current collector bonded to another surface of the bipolar plate by an adhesive;
a negative active material layer placed on the negative current collector; and
a cover plate covering a peripheral edge portion of the positive current collector.

2. The bipolar storage battery according to claim 1, wherein the positive current collector and the negative current collector are made of lead or a lead alloy.

3. The bipolar storage battery according to claim 1, wherein the cover plate covers an end portion of a positive electrode that includes the positive current collector and the positive active material layer, and the cover plate has a frame shape.

4. The bipolar storage battery according to claim 3, wherein the positive current collector and the negative current collector are made of lead or a lead alloy.

5. The bipolar storage battery according to claim 1, wherein the cover plate is placed at least on an adhesive provided on a positive electrode that includes the positive current collector and the positive active material layer, and one end of the cover plate is placed to cover a region on which the adhesive is provided.

6. The bipolar storage battery according to claim 5, wherein the positive current collector and the negative current collector are made of lead or a lead alloy.

7. The bipolar storage battery according to claim 5, wherein the cover plate covers an end portion of a positive electrode that includes the positive current collector and the positive active material layer, and the cover plate has a frame shape.

8. The bipolar storage battery according to claim 1, wherein the cover plate is made of an acrylonitrile-butadiene-styrene copolymer or polypropylene.

9. The bipolar storage battery according to claim 8, wherein the positive current collector and the negative current collector are made of lead or a lead alloy.

10. The bipolar storage battery according to claim 8, wherein the cover plate covers an end portion of a positive electrode that includes the positive current collector and the positive active material layer, and the cover plate has a frame shape.

11. The bipolar storage battery according to claim 8, wherein the cover plate is placed at least on an adhesive provided on a positive electrode that includes the positive current collector and the positive active material layer, and one end of the cover plate is placed to cover a region on which the adhesive is provided.

12. The bipolar storage battery according to claim 1, wherein the peripheral edge portion includes a peripheral edge portion of the support column, and the cover plate covers the peripheral edge portion of the support column.

13. The bipolar storage battery according to claim 12, wherein the positive current collector and the negative current collector are made of lead or a lead alloy.

14. The bipolar storage battery according to claim 12, wherein the cover plate is placed at least on an adhesive provided on a positive electrode that includes the positive current collector and the positive active material layer, and one end of the cover plate is placed to cover a region on which the adhesive is provided.

15. The bipolar storage battery according to claim 12, wherein the cover plate is made of an acrylonitrile-butadiene-styrene copolymer or polypropylene.
